(19) United States
(12) Patent Application Publication
(10) Pub. No.: US 2022/0363045 A1
(43) Pub. Date: Nov. 17, 2022

(54) ELECTRICALLY DIMMABLE GLAZING

(71) Applicants: Covestro Intellectual Property GmbH & Co. KG, Leverkusen (DE); OPAK Smart Glas GmbH, Köln (DE)

(72) Inventors: Rainer Hagen, Leverkusen (DE); Andreas Klein, Leverkusen (DE); Hamid-Reza Najaf Pour Aghcheshmeh, GE Heerlen (NL)

(21) Appl. No.: 17/767,102

(22) PCT Filed: Oct. 8, 2020
(86) PCT No.: PCT/EP2020/078210

§ 371 Date: Apr. 7, 2022

(30) Foreign Application Priority Data
Oct. 15, 2019 (EP) 19203193.8

(51) Int. Cl. B32B 37/02; B32B 7/08; B32B 7/023; B32B 27/16; B32B 27/08; B32B 27/36

(52) U.S. Cl. CPC B32B 37/02; B32B 7/08; B32B 7/023; B32B 27/16; B32B 27/08; B32B 27/365; B32B 2250/03; B32B 2250/24; B32B 2250/40; B32B 2307/202; B32B 2307/306; B32B 2307/412; B32B 2307/42; B32B 2307/538; B32B 2307/732; B32B 2255/10; B32B 2307/584; B32B 2305/55; B32B 2255/205; B32B 2369/00; B32B 2457/202; B32B 2255/26

(57) ABSTRACT

The present invention relates to a specific multilayer composite which is suitable as a constituent of liquid-crystal devices and which contains two specific polycarbonate layers inter alia. The invention further relates to a method of producing the multilayer composite. The invention further relates to a liquid-crystal device comprising a multilayer composite according to the present invention, to a method of production thereof, and to the use thereof as structural glazing, in automotive glass, as floodlight cover, in optical filters, in shutters, in flat visual display screens, in glazed advertising devices, in dividing walls of trains, and in point-of-interest devices.

The present invention relates to a specific multilayer composite which is suitable as a constituent of liquid-crystal devices and which contains two specific polycarbonate layers inter alia. The invention further relates to a method of producing the multilayer composite. The invention further relates to a liquid-crystal device comprising a multilayer composite according to the present invention, to a method of production thereof, and to the use thereof as structural glazing, in automotive glass, as floodlight cover, in optical filters, in shutters, in flat visual display screens, in glazed advertising devices, in dividing walls of trains, and in point-of-interest devices.

Smart glasses, the transparency of which changes as a result of the application of an electrical voltage, are known. According to their design, these glasses may serve, for example, as sunscreen (glass changes color while remaining transparent) or assume the function of a sightscreen (glass becomes translucent). The fields of use range, for example, from structural glazing for windows and doors, dividing walls in trains, automotive glazing, floodlight covers, optical filters and shutters, flat visual display screens, and extend as far as displays for advertizing and points of interest.

DE 3816069 A1 describes an insert or front attachment for windows or doors, in which the use of electrically orientable liquid-crystal elements can establish transparency or opacity. The switchover function involves use of rotating liquid-crystal cells between two polarization filters. This arrangement becomes opaque when an electrical voltage is applied. This technology is now widely known and described and finds use in liquid-crystal display elements. The polarization filter makes the switchable element costly and complex.

WO 92/12219 A1 describes a technology based on polymer-dispersed liquid crystals (PDLC) that does not need a polarization filter. In PDLC technology, nematic liquid crystals are dispersed into a UV-curing polymer film, so as to form an emulsion containing tiny droplets of liquid, which can be introduced between preferably transparent polymer films equipped with two-dimensional electrodes. On application of an electrical voltage to the electrodes, the liquid-crystal molecules become oriented along the field lines, which leads to a transparent state, while the molecules become aligned to the droplet surfaces without a field, which leads to light scatter, i.e. a translucent state of the film composite. The electrical switching voltage here is not less than 15 volts. Application of different voltages can establish different specular transmittances. Reference is made to dimmable elements, by way of linguistic distinction from switchable elements that are optimized for two switching states in particular.

EP 0927753 A1 describes a reverse-switching PDLC technology, also referred to as liquid-crystal-dispersed polymer (LCDP), which has a polymer droplet morphology rather than the liquid-crystal droplet morphology just described. It is characterized by a transparent “off” state (no electrical field applied) and a translucent “on” state (electrical field applied). PDLC technologies utilize conductively coated glasses or films as substrates. Films are easy to handle and therefore preferred.

WO2019020298A1 also describes a layer structure for use in vehicle glazing, the transparency of which is variable by applying an electrical voltage, especially by applying a voltage between a transparent state and a cloudy or opaque state.

However, the production of PDLC and LCDP liquid-crystal devices has often been complex to date and is associated with difficulties with regard to quality, especially in commercial production.

One cause of quality problems is described in U.S. Pat. No. 5,867,238: The curing of the polymer matrix into which the liquid crystals are embedded, by virtue of the actinic UV light, gives rise to high thermal stresses for the substrates to be coated. The current state of the art is PDLC film composites consisting of two external transparent PET (polyethylene terephthalate) substrates. These embed the PDLC layer. The PET films are equipped on one side with a conductive metal oxide layer of thickness about 100 to 500 mm, e.g. ITO (indium tin oxide) layer, via which an electrical field can be applied to the PDLC layer. But PET films are subject to thermal warpage and have low resilience, i.e. show a low tendency to healing. This complicates processing and harbors the risk that there will be thermal or mechanical fractures in the ITO layer. Broken ITO electrodes, however, lead to inhomogeneous voltage distributions and field lines, and this in turn to fluctuations in transmission, i.e. visible spots in the PDLC pane.

U.S. Pat. No. 4,963,206 describes a switchable element with an alternative conductive layer of conjugated conductive polymer. Polymers are naturally more mechanically robust and less brittle than vapor-deposited metal oxide layers, for example ITO. But conductive polymers tend to have higher sheet resistances compared to ITO. Polymers also have a tendency to build up space charges at elevated temperature, which can reduce conductivity. Moreover, conductive polymers show slight coloring in the visible spectral region. On account of these problems, they have not become established to date in optical applications.

It was consequently an object of the present invention to provide a multilayer composite for the liquid-crystal device or said device itself, said composite being relatively easy to produce commercially, providing good quality, being suitable for optical applications and having low sheet resistance. More particularly, the multilayer composite for a liquid crystal device or said device itself, in all switching states and at all voltage levels, is to have high constancy in specular transmittance across the active area.

This object was achieved by the inventors through the use of specific polycarbonate layers having a clear hardcoat coating rather than a standard PET layer. More particularly, it is advantageous if the conductive layers of the composite are ITO or IMITO (index-matched indium tin oxide) layers. These conductive layers are transparent and electrically conductive.

It was surprising here that the “simple” polycarbonate layers known and available on the market, also referred to as films in the specialist field, which do not have a clear hardcoat coating are unsuitable. This is because, even though the better dimensional stability of films of polycarbonate (PC) compared to PET films at elevated temperatures is known, these do not have an entirely planar, defect-free surface, with the result that any conductive layer applied, especially ITO or IMITO coating, will also have inhomogeneities, i.e. defects. Optimization of the PC extrusion process for avoidance of the inhomogeneities is complex, since even smooth-polished metallic extrusion rolls sustain damage in prolonged operation and have to be replaced frequently. Moreover, PC films are generally scratch-sensitive. ITO coating on extruded “simple” polycarbonate films is consequently not a suitable method by which it would be possible to achieve the stated object. However, it has been found that, surprisingly, polycarbonate layers with a hardcoat coating are suitable for achieving the object.

Therefore, the invention, in a first aspect, relates to a multilayer composite with sandwich structure which is suitable as a constituent of liquid-crystal devices, comprising or consisting of:

a core layer consisting either of a polymer matrix with nematic liquid crystals dispersed therein or a liquid-crystal matrix with polymers dispersed therein;

two conductive layers each disposed on one surface of the core layer and hence enclosing it, where the conductive layers are transparent and electrically conductive;

two polycarbonate layers each disposed on that surface of the conductive layers which is remote from the core layer and each having a clear hardcoat coating on the side facing the core layer, and where the polycarbonate layers are transparent.

In a second aspect, the invention relates to a method of producing a multilayer composite according to the present invention, comprising or consisting of the following steps:
(i) providing two conductive layers and two polycarbonate layers, where the polycarbonate layers have a clear hardcoat coating on one side and optionally an antiblocking hardcoat layer on the other side, and applying a conductive layer to each polycarbonate layer, where the conductive layer is applied on the side of the polycarbonate layer with a clear hardcoat coating in order to obtain a first composite;
(ii) applying the core layer to the conductive layer of a first composite by means of knife coating, casting or printing in order to obtain a second composite;
(iii) applying the further first composite to the core layer of the second composite, where the conductive layer of the first composite is applied to the second composite by means of lamination or pressing, especially in conjunction with UV curing, in order to obtain a third composite.

In a third aspect, the present invention relates to a liquid-crystal device comprising a multilayer composite according to the present invention, disposed between two sheets, wherein the conductive layers are connected to a voltage source.

In a fourth aspect, the invention relates to a method of producing a liquid-crystal device according to the present invention, comprising or consisting of the following steps:

securing two sheets, each on one side of the multilayer composite according to the present invention.

In a fifth aspect, the present invention relates to the use of the liquid-crystal device according to the present invention as structural glazing, in automotive glass, as floodlight cover, in optical filters, in shutters, in flat visual display screens, in glazed advertising devices, in dividing walls of trains, and in point-of-interest devices.

These and further embodiments, features and advantages of the invention will be apparent to the person skilled in the art from studying the detailed description and claims that follow. It is possible here for the individually described features or embodiments of the invention to be combined with all other features or embodiments of the invention without explicit description thereof in combination within the scope of the invention. It will be appreciated that the examples included herein are intended to describe and illustrate the invention, but not to restrict it, and the invention is especially not limited to the examples.

Numerical values specified herein without decimal places each refer to the full value specified with one decimal place. For example, “99%” signifies “99.0%”.

Numerical ranges given in the format “in/from x to y” include the values stated. If two or more preferred numerical ranges are given in this format, it is understood that all ranges arising from the combination of the various end points are likewise encompassed.

In the context of the present invention, an article, for example a layer, a film, a composite or a device, is considered to be transparent when its transmittance Ty is at least 75%, preferably at least 80%, more preferably at least 85%, especially preferably at least 88%, and its haze is additionally less than 5% and preferably less than 3.5%. Transmittance Ty is determined to ISO 13468-2:2006-07 (D65, 10°). Haze is determined to ASTM D1003:2013. If transmittance is less than 75% or haze is more than 5%, the article is considered to be nontransparent. In the composite and the device, the determination of transparency and transmittance is of course conducted in the state of the core layer in which it is supposed to be transparent. In other words with the voltage applied in the case of a core layer of the PDLC type, and in the absence of voltage in the case of the LCDP type.

The invention relates more particularly to:
1. A multilayer composite with sandwich structure which is suitable as a constituent of liquid-crystal devices, comprising or consisting of:
   a core layer consisting either of a polymer matrix with nematic liquid crystals dispersed therein or a liquid-crystal matrix with polymers dispersed therein;
   two conductive layers each disposed on one surface of the core layer and hence enclosing it, where the conductive layers are transparent and electrically conductive;
   two polycarbonate layers each disposed on that surface of the conductive layers which is remote from the core layer and each having a clear hardcoat coating on the side facing the core layer, and where the polycarbonate layers are transparent; and
   optionally
   two antiblocking hardcoat layers each disposed on that surface of the polycarbonate layers which is remote from the core layer, where the antiblocking hardcoat layers are transparent; and/or
   two adhesive layers each disposed on that surface of the polycarbonate layers or, if present, of the antiblocking hardcoat layers which is remote from the core layer, where the adhesive layers are transparent.
2. The multilayer composite according to embodiment 1, characterized in that the core layer
(i) has a thickness of 100 to 200 μm; and/or
(ii) has a polymer matrix produced from UV-curable polymerizable monomers, preferably from urethane-acrylic or epoxy; and/or
(iii) has liquid crystals selected from one of the classes of nematic, smectic, ferroelectric or organometallic mesogens, including the class of polymerizable liquid crystals.
3. The multilayer composite according to either of the preceding embodiments, characterized in that the conductive layers
(i) have a thickness of 20 to 50 nm; and/or
(ii) are the same or different; and/or
(iii) consist of ITO (indium tin oxide, In₂₋ₓSnₓO₃), preferably with a tin content of up to 25% by weight, more preferably 20% by weight, IMITO (index-matched indium tin oxide), tin oxide or gallium-doped tin oxide, preferably ITO or IMITO, more preferably IMITO; and/or
(iv) have a maximum roughness of the surface of Ra<0.1 μm, preferably <0.05 μm, most preferably of less than 0.025 μm, determined to DIN EN ISO 1302:2002-06; and/or
(v) have a specific sheet resistance R_{□} of less than 100 ohms, preferably less than 90 ohms.
4. The multilayer composite according to any of the preceding embodiments, characterized in that the polycarbonate layers
(i) have a thickness of 90 to 1000 μm, preferably 125 to 375 μm; and/or
(ii) are the same or different; and/or
(iii) consist of amorphous polycarbonate; and/or
(iv) have a transmittance Ty of at least 86%, preferably at least 87%; and/or
(v) have a haze of less than 2%, preferably less than 1%; and/or
(vi) are extruded polycarbonate layers; and/or
(vii) have a clear hardcoat coating which is a lacquer coating, preferably a scratch-resistant lacquer coating, more preferably consists of a silicon oxide layer optionally having an underlayer of organosiloxanes, acrylates or polyolefins which functions as a bonding layer to the polycarbonate layer, and which preferably has a thickness of less than 10 μm, preferably of 3 to 5 μm; and/or
(viii) have a Vicat softening temperature of 145 to 160° C., preferably of 150 to 160° C., determined by test method ISO 306:2014-03 and the B50 method (test load 50 N; heating rate 50 K/h; pressboard in oil); and/or
(ix) have a melting range of 220 to 230° C.; and/or
(x) have a burn rate of <100 mm/min, determined by test method US-FMVSS 302.
5. The multilayer composite according to any of the preceding embodiments, characterized in that the antiblocking hardcoat layers
(i) have a thickness of 0.5 to 12 μm, preferably 2 to 8 μm; and/or
(ii) are the same or different; and/or
(iii) consist of silicon oxide layers, admixed with silicas, or wax additives, such as paraffin waxes.
6. A method of producing a multilayer composite according to the present invention, comprising or consisting of the following steps:
(i) providing two conductive layers and two polycarbonate layers, where the polycarbonate layers have a clear hardcoat coating on one side and optionally an antiblocking hardcoat layer on the other side, and applying a conductive layer to each polycarbonate layer, where the conductive layer is applied on the side of the polycarbonate layer with a clear hardcoat coating, preferably by means of cathodic atomization (sputtering), by reactive thermal evaporation or sol-gel methods, in order to obtain a first composite;
(ii) applying the core layer to the conductive layer of a first composite by means of knife coating, casting or printing in order to obtain a second composite;
(iii) applying the further first composite to the core layer of the second composite, where the conductive layer of the first composite is applied to the second composite by means of lamination or pressing, especially in conjunction with UV curing, in order to obtain a third composite;
(iv) optionally applying two antiblocking hardcoat layers, if not already present in step (i), to the two faces of the third composite in order to obtain a fourth composite; and/or
(v) optionally applying two adhesive layers to the two faces of the third or fourth composite in order to obtain an alternative fourth or a fifth composite; and/or
(vi) optionally subjecting the third, fourth or fifth composite to overmolding or in-mold coating by the injection molding method.
7. A polymer-dispersed liquid-crystal device comprising a multilayer composite according to the present invention, disposed between two sheets, wherein the conductive layers are connected to a voltage source, said sheets preferably consisting of polycarbonate, polymethylmethacrylate or glass.
8. A method of producing a polymer-dispersed liquid-crystal device according to embodiment 7, comprising or consisting of the following steps:
securing two sheets, each on one side of the multilayer composite according to the present invention, where the securing is preferably an adhesive bonding and/or the sheets consist of polycarbonate, polymethylmethacrylate or glass.
9. The use of the polymer-dispersed liquid-crystal device according to embodiment 7 as structural glazing, in automotive glass, especially mirrors and glazing, as floodlight cover, in optical filters, in shutters, in flat visual display screens, in glazed advertizing devices and in point-of-interest devices.

The multilayer composite of the present invention is in what is called a sandwich structure. This means that a core layer, the transparency of which can vary as a result of application of voltage, is surrounded symmetrically at least by in each case two conductive layers and two polycarbonate layers.

The core layer here is the commercially available layer known in the prior art which consists either of a polymer matrix with nematic liquid crystals dispersed therein or consists of a liquid-crystal matrix with polymers dispersed therein, and which has been described for use in liquid-crystal devices. The core layer is thus capable of changing transparency on application of electrical voltage. This layer, also referred to as liquid-crystal material, is described, for example, in H. Sun et. al. “Dye-Doped Electrically Smart Windows Based on Polymer-Stabilized Liquid Crystal”, Polymers 2019, 11, pages 694 ff.; EP 0927753 A1 and WO 92/11219 A1. Polymerizable liquid crystals suitable for the present invention are likewise described in US 2019/071605 A1. Other suitable mesogens for the present invention are described, for example, in WO 95/01410. They are also commercially available, for example, under the Lixon® trade name from JNC Corporation. In the present invention, both PDLC liquid-crystal materials (i.e. a polymer matrix with dispersed nematic liquid crystals) and LCDP liquid-crystal materials (i.e. a liquid-crystal matrix with dispersed polymers) are suitable.

The core layer preferably has a thickness of 100 to 200 μm. It is further preferable that a PDLC core layer has a transmittance Ty of at least 86%, preferably at least 87%, with voltage applied; and/or a haze of less than 2%, preferably less than 1%, with voltage applied. It is further preferable that a LCDP core layer has a transmittance Ty of at least 86%, preferably at least 87%, in the absence of voltage; and/or a haze of less than 2%, preferably less than 1%, in the absence of voltage.

The conductive layer is a transparent and electrically conductive layer. This preferably has a specific sheet resistance R of less than 100 ohms, preferably less than 90 ohms, determined, for example, by the four-point measurement according to Van der Pauw or by optical transmittance and/or reflectance measurements in the visible and infrared wavelength range on the basis of a calibration curve that establishes the correlation between the optical spectrum and sheet resistance by means of a physical model. The conductive layer preferably has a transmittance Ty of at least 86%, preferably at least 87%; and/or a haze of less than 2%, preferably less than 1%.

Suitable materials for the conductive layer are especially ITO (indium tin oxide, In₂₋ₓSnₓO₃), preferably with a tin content of up to 25% by weight, more preferably 20% by weight, IMITO (index-matched indium tin oxide), tin oxide or gallium-doped tin oxide, more preferably ITO or IMITO, most preferably IMITO. These materials too are known to those skilled in the art and commercially available. If the layer is an IMITO layer, the index-matched layer present in the conductive layer faces away from the core layer in the composite.

The polycarbonate layer is a transparent layer and has a clear hardcoat coating on one side. This clear hardcoat coating is preferably a lacquer layer, especially a scratch-resistant lacquer layer. The lacquer layer is preferably based on silicone or acrylic, especially silicone. The clear hardcoat coating is applied, for example, by the flow coating method with thermal curing or UV curing.

The polycarbonate layer preferably has a thickness of 90 to 1000 μm, and the clear hardcoat coating present has a thickness of less than 10 μm, more preferably of 3 to 5 μm. Without being tied to any theory, it is assumed that the specific polycarbonate layer acts as a planarizer for the conductive layer and hence the excellent transparency of the composite can be achieved. There is barely any distortion, if any, of an image viewed through the system by eye or camera. Especially suitable thicknesses have been found to be less than 10 μm for the clear hardcoat coating. The polycarbonate layers may preferably be extruded polycarbonate layers to which the clear hardcoat coating is applied subsequently.

More particularly, preference is given to amorphous polycarbonate. The polycarbonate layer preferably has a softening temperature of 150 to 160° C. and/or a melting range of 220 to 230° C. Also advantageous is a burn rate of <100 mm/min, determined by test method US-FMVSS 302.

The polycarbonate layer preferably has a transmittance Ty of at least 86%, preferably at least 87%; and/or a haze of less than 2%, preferably less than 1%.

One commercially available example is Makrofol® HS340 G-1 020010 from Covestro AG. The commercially available polycarbonate layers (also referred to as films) often have removable protective polyethylene films.

The above-described polycarbonate layers can preferably withstand brief thermal stress, for example for up to one minute, at 135 to 140° C. The presence of the clear hardcoat coating makes the coated side scratch-resistant and chemical-resistant, and protects it from UV radiation. In addition, the polycarbonate layer has very good electrical insulation properties and very good dielectric properties. They generally have good mechanical durability and can be printed on the unlacquered side.

The multilayer composite may also optionally have two antiblocking hardcoat layers and/or two adhesive layers that are likewise transparent.

The antiblocking hardcoat layer preferably has a low coefficient of friction and/or a fine particle distribution. Antiblocking hardcoat layers are commercially available and consist of silicon oxide layers with added silicas or wax additives, such as paraffin waxes. The antiblocking hardcoat layer preferably has a transmittance Ty of at least 86%, preferably at least 87%; and/or a haze of less than 2%, preferably less than 1%.

The antiblocking hardcoat layer may already be present on the polycarbonate layer or may be applied later to a sandwich composite composed of core layer, conductive layers and polycarbonate layers atop both polycarbonate layers, in each case to the side facing away from the core layer. Suitable polycarbonate layers already having an antiblocking hardcoat layer are described, for example, in WO 2015/044275 A1.

Suitable optional adhesive layers are known to the person skilled in the art and are obtained, for example, from adhesion-creating solvents, adhesive lacquers or reactive adhesives.

The multilayer composite of the present invention is produced by applying a conductive layer to each polycarbonate layer, with the conductive layer being applied on the side of the polycarbonate layer with a clear hardcoat coating, preferably by means of cathodic atomization (sputtering), by reactive thermal evaporation or by sol-gel methods in order to obtain a first composite. Preference is given here to reactive thermal evaporation under air at temperatures above 300° C., and to the sol-gel method for large areas, especially larger than 500×500 mm. In the next step, the core layer is applied to the conductive layer of a first composite by means of knife coating, casting or printing in order to obtain a second composite. On this composite, a further first composite is applied to the second composite, where the conductive layer of the first composite is applied to the second composite by means of lamination or pressing, especially in conjunction with UV curing, in order to obtain a third composite. In the next step, it is possible to apply two antiblocking hardcoat layers and/or two adhesive layers. The composite may optionally be subjected to overmolding or in-mold coating by an injection molding method.

The present invention further comprises a liquid-crystal device comprising a multilayer composite according to the present invention, disposed between two sheets, wherein the conductive layers are connected to a voltage source, said sheets preferably consisting of polycarbonate, polymethylmethacrylate or glass.

The liquid-crystal device is produced here by securing two sheets, one sheet on each side of the multilayer composite according to the present invention, where the securing is preferably an adhesive bonding and/or the sheets consist of polycarbonate, polymethylmethacrylate or glass. Suitable adhesives are sticky solvents, adhesive lacquers or reactive adhesives. In addition, it is possible to use heat and/or pressure to enable the bonding, especially an ultrasound method.

The liquid-crystal device may especially be used as structural glazing, in automotive glass, especially mirrors and glazing, as floodlight cover, in optical filters, in shutters, in flat visual display screens, in glazed advertizing devices and in point-of-interest devices. Particular preference is given to LDCP liquid-crystal devices in automotive glazing, since these is usually supposed to be transparent and LDCP technology is thus energy-saving.

The present invention is to be illustrated by the examples and figures that follow, without any intention that the invention be limited to these examples and figures.

### EXAMPLE 1 (INVENTIVE)

### Measurement of Light Transmittance and Haze on a Test Specimen Made of a Multilayer Composite According to the Invention

A test specimen was produced from a multilayer composite according to the invention using a polycarbonate film of the commercially available Makrofol® HS340 G-1 020010 type manufactured at Covestro Deutschland AG, provided on one side (front side) with a high-gloss hardcoat layer of silicon oxide and shiny on the opposite side (reverse side). This film of thickness 385 μm (test method: ISO 4593:1993-11) was used in the form of roll material and was coated on the front side with indium tin oxide (ITO) in a sputtering method. The resistance of the ITO layer was (90±5) Ω/□. The film thus produced was cut into leaves, i.e. leaf material, in about 200 mm×300 mm format. The leaf material thus obtained is also referred to for short as “PC-ITO leaves”—“PC-ITO leaf” in the singular.

Two such PC-ITO leaves according to this example 1 were used hereinafter as substrates for the test specimen in the multilayer composite according to the invention. It has been found that the applying of a polymer-dispersed liquid-crystal paste (PDLC paste) led to production of a PDLC layer by means of knife-coating on the ITO layer on account of the good surface planarity of the PC-ITO leaf having high constancy of thickness with values around 150 μm. Methods of producing encapsulated liquid crystals and producing a continuous PDLC layer on a carrier material have been described before and were employed here. They are based on the photochemical polymerization of UV-curing mixtures consisting of monomers, crosslinkers, photoinitiators and liquid-crystal mixtures. Details of the processes can be gleaned, for example, in the patent specification U.S. Pat. No. 4,435,047 A by Fergason J. L., “Encapsulated liquid crystal and method” and in Kashima M, Cao H, Meng Q, Liu H, Wang D, Li F, et al., “The influence of crosslinking agents on the morphology and electro-optical performances of PDLC films”, J. Appl. Pol. Sci. 2010 (117), 3434-3440. The PDLC layer has been distributed up to the edge of the PC-ITO leaf. The PDLC layer was sealed by means of a second PC-ITO leaf according to this example 1. This was done in such a way that the respective ITO layers of the two PC-ITO leaves were disposed directly atop the PDLC layer, i.e. the ITO layers of the two PC-ITO leaves were separated from one another solely by the PDLC layer.

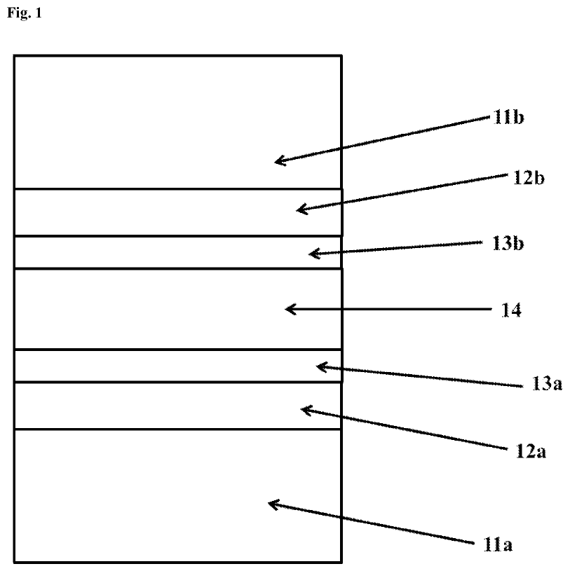

FIG. 1 shows the schematic construction of a multilayer structure according to the invention (not to scale). In this figure:
11a Polycarbonate layer of the first PC-ITO leaf
12a Hardcoat layer of the first PC-ITO leaf
13a ITO layer of the first PC-ITO leaf
14 PDLC layer
13b ITO layer of the second PC-ITO leaf
12b Hardcoat layer of the second PC-ITO leaf
11b Polycarbonate layer of the second PC-ITO leaf

The total thickness of the multilayer composite according to the invention thus obtained was 920 to 930 μm as measured with a micrometer screw. For electrical contact connection, wires were connected to an outer edge by means of metal spring clamps, one for each PC-ITO leaf. For the contact connection of the ITO layer 13a of the first PC-ITO leaf, the second PC-ITO leaf was lifted briefly with a scalpel, i.e. the composite was separated at the PDLC layer 14, and about 1 cm² was cut away from the edge of the second PC-ITO leaf. At this point, it was possible to contact the ITO layer 13a of the first PC-ITO leaf with the spring clamp Electrical contact improves if the PDLC layer 14 above the ITO is rubbed away mechanically. The procedure is similar for the contacting of the ITO layer 14a of the second PC-ITO leaf; in this case, a portion of the first PC-ITO leaf is cut away. It is thus possible to establish the second contact with the second electrode. The two contacts are a few centimetres apart, for example, but on the same edge of the multilayer composite. It was thus possible to apply electrical fields to the PDLC via its two adjacent electrically conductive ITO layers by the principle of a plate capacitor. Further cutting-to-size of the multilayer composite according to the invention thus obtained was necessary for the measurement in the sample chambers of the optical measurement devices, and was done by cutting to size with scissors. A test specimen of the multilayer composite according to the invention was obtained.

A test specimen of width about 120 mm was analysed for haze and transmittance in a Hazemeter NDH 2000 (from Nippon Denshoku Industries Co., Ltd.) with D65 standard illuminant, once in each case without voltage applied (0 volts) and once with voltage (36 volts).

The measurement results can be found in table 1.

The test specimen of the multilayer composite according to the invention has high haze in the normal state of 97.26% and high transmittance of 88.87% with simultaneously low residual haze of 4.0% in the switched-on state.

Comparison with the haze value of the polycarbonate film Makrofol® HS340 G-1 020010 with a hardcoat layer that has neither an ITO layer nor a PDLC layer and otherwise corresponds to the film, which was used for production of the multilayer structure according to the invention, of 0.98% shows that the contribution of the PDLC layer to the total haze of the test specimen in the connected state is small.

TABLE 1
Optical properties of a multilayer composite according
to the invention in the connected (voltage 36 volts)
and unconnected initial state (0 volts)

| Voltage [V (DC)] | Transmittance [%] | Haze [%] |
|---|---|---|
| 0 | 81.51 | 97.26 |
| 36 | 88.87 | 4.0 |

### EXAMPLE 2 (COMPARATIVE)

### Measurement of Light Transmittance and Haze on a PET-Based Test Specimen not According to the Invention

By comparison with the multilayer composite according to the invention from example 1, a test specimen composed of commercially available PET-ITO layer composite, TL42 from OPAK Smart Glas GmbH, was employed. The PET-ITO layer composite TL42 has a PDLC core layer, the chemical feedstocks and formulation of which are identical to the core layer from example 1. The two carrier films are 188 μm-thick PET with an ITO layer.

The respective ITO layers of the two carrier films of the PET-ITO layer composite TL42 are disposed directly atop the PDLC layer; in other words, the ITO layers of the two carrier films of the PET-ITO layer composite TL42 were separated from one another solely by the PDLC layer.

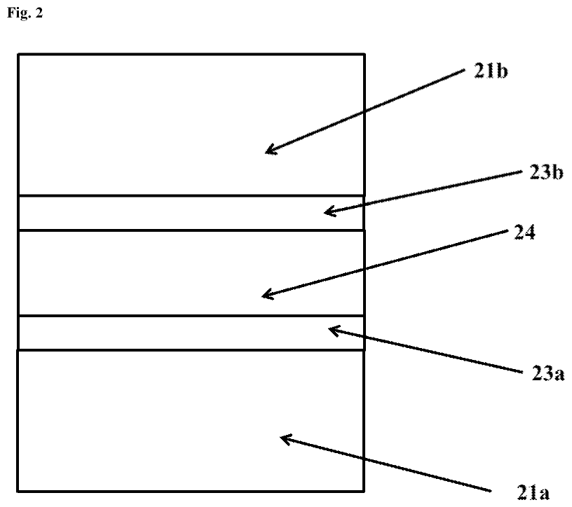

FIG. 2 shows the schematic structure of the PET-ITO layer composite TL42 (not to scale). In this figure:
21a PET layer
23a ITO layer
24 PDLC layer
23b ITO layer
21b PET layer

The measurement results for haze and transmittance can be found in table 2.

TABLE 2
Optical properties of the test specimen not according
to the invention based on a PET-ITO layer composite TL42
(comparative test specimen) in the connected (voltage
65 volts) and unconnected initial state (0 volts)

| Voltage [V (DC)] | Transmittance [%] | Haze [%] |
|---|---|---|
| 0 | 75.36 | 97.26 |
| 65 | 81.89 | 4.10 |

The comparative test specimen has high haze in the normal state of 97.26%. This is identical to the multilayer composite according to the invention.

The comparative test specimen in the connected state, in spite of the high voltage applied, has comparatively low transmittance of 81.89% and high residual haze of 4.10%.

Comparison with the haze value of an uncoated PET film of 0.8% shows that the contribution of the PDLC layer to the total haze of the comparative test specimen in the connected state is high, especially higher than in the multilayer composite according to the invention from example 1.

### EXAMPLE 3 (COMPARATIVE)

### Measurement of Light Transmittance and Haze on a Test Specimen not According to the Invention Based on Polycarbonate

By comparison with the multilayer composite according to the invention from example 1, a commercially available high-gloss polycarbonate film, Makrofol® DE 1-1 from Covestro Deutschland AG, was used in example 3 for the reverse side of the test specimen to be produced. This film was cut into leaves—here too called “PC-ITO leaves” or in the singular “PC-ITO leaf”—each with an about 150 mm×150 mm format, and these PC-ITO leaves were individually coated on the front side with indium tin oxide (ITO) in a sputtering method. The resistance of the ICO layer was (90±5) Ω/□.

Such a PC-ITO leaf not according to the invention according to this example 3 and a PC-ITO leaf according to the invention from example 1, produced according to example 1, were then respectively used for the reverse side and the front side of the PDLC specimen to be constructed. The process for producing the test specimen according to this example 3 corresponds to that from example 1.

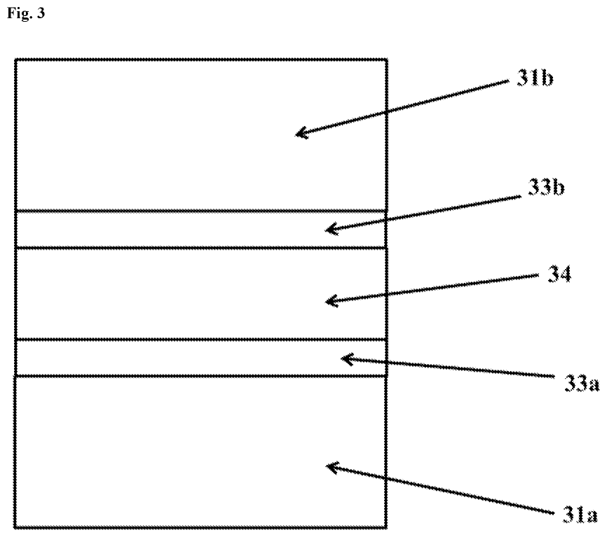

FIG. 3 shows the schematic construction of a test specimen according to this example 3 (not to scale). In this figure:
31a Polycarbonate layer of the first PC-ITO leaf
33a ITO layer of the first PC-ITO leaf
34 PDLC layer
33b ITO layer of the second PC-ITO leaf
31b Polycarbonate layer of the second PC-ITO leaf

The Makrofol® DE 1-1 film was 385 μm thick (test method: ISO 4593:1993-11).

A test specimen of width about 50 mm was analysed for haze and transmittance in a Hazemeter NDH 2000 (from Nippon Denshoku Industries Co., Ltd.) with D65 standard illuminant, once in each case without voltage applied (0 volts) and once with voltage (36 volts).

The measurement results can be found in table 3.

The test specimen according to this example 3 in the opaque normal state has lower haze compared to the test specimen according to the invention from example 1 (91.39% compared to 97.26%).

The test specimen according to this example 3 in the transparent connected state has lower transmittance compared to the test specimen according to the invention from example 1 (84.83% compared to 88.87%) and simultaneously higher residual haze (3.99% compared to 3.74%). This demonstrates that the specimen not according to the invention (with a PC film lacking a scratch-resistant finish) in both connection states is worse in terms of optical properties than the specimen according to the invention.

TABLE 3
Optical properties of a noninventive PC-based PDLC
test specimen in the connected (voltage 36 volts)
and unconnected initial state (0 volts)

| Voltage [V (DC)] | Transmittance [%] | Haze [%] |
|---|---|---|
| 0 | 75.42 | 91.39 |
| 36 | 84.83 | 3.99 |

1. A multilayer composite with sandwich structure which is suitable as a constituent of liquid-crystal devices, comprising:
a core layer consisting of one of a polymer matrix with nematic liquid crystals dispersed therein or a liquid-crystal matrix with polymers dispersed therein;
two conductive layers each disposed on one surface of the core layer and enclosing the core layer, wherein the conductive layers are transparent and electrically conductive;
two polycarbonate layers each disposed on a surface of the conductive layers which is remote from the core layer and each layer having a clear hardcoat coating on a side facing the core layer, and wherein the polycarbonate layers are transparent; and
optionally
two antiblocking hardcoat layers each layer disposed on a surface of the polycarbonate layers which is remote from the core layer, wherein the antiblocking hardcoat layers are transparent; and/or
two adhesive layers each layer disposed on a surface of the polycarbonate layers or, if present, of the antiblocking hardcoat layers which is remote from the core layer, where the adhesive layers are transparent.

2. The multilayer composite as claimed in claim 1, characterized in that the core layer
(i) has a thickness of 100 to 200 μm; and/or
(ii) has a polymer matrix produced from UV-curable polymerizable monomers; and/or
(iii) has liquid crystals selected from one of the classes of nematic, smectic, ferroelectric or organometallic mesogens, including the class of polymerizable liquid crystals.

3. The multilayer composite as claimed in claim 1, characterized in that the conductive layers
(i) have a thickness of 20 to 50 nm;
(ii) are the same or different;
(iii) one selected from the group consisting of ITO, IMITO, tin oxide, and gallium-doped tin oxide;
(iv) have a maximum roughness of the surface of Ra<0.1 μm, determined to DIN EN ISO 1302:2002-06; and
(v) have a specific sheet resistance R_{□} of less than 100 ohms.

4. The multilayer composite as claimed in claim 1, characterized in that the polycarbonate layers
(i) have a thickness of 90 to 1000 μm;
(ii) are the same or different;
(iii) consist of amorphous polycarbonate;
(iv) have a transmittance Ty of at least 86%;
(v) have a haze of less than 2%;
(vi) are extruded polycarbonate layers;
(vii) have a clear hardcoat coating which is a lacquer coating;
(viii) have a Vicat softening temperature of 145 to 160° C., determined by test method ISO 306:2014-03 and the B50 method (test load 50 N; heating rate 50 K/h; pressboard in oil);
(ix) have a melting range of 220 to 230° C.; and/or
(x) have a burn rate of ≤100 mm/min, determined by test method US-FMVSS 302.

5. The multilayer composite as claimed in claim 1, characterized in that the antiblocking hardcoat layers
(i) have a thickness of 0.5 to 12 μm;
(ii) are the same or different; and
(iii) are selected from the group consisting of silicon oxide layers, admixed with silicas and wax additives.

6. A method of producing a multilayer composite as claimed in claim 1, comprising the following steps:
(i) providing two conductive layers and two polycarbonate layers, wherein the polycarbonate layers have a clear hardcoat coating on a first side and optionally an antiblocking hardcoat layer on a second side, and applying a conductive layer to each polycarbonate layer, wherein the conductive layer is applied on the side of the polycarbonate layer having a clear hardcoat coating to produce a first composite;
(ii) applying the core layer to the conductive layer of a first composite by one selected from the group consisting of knife coating, casting, and printing to produce a second composite;
(iii) applying the first composite to the core layer of the second composite, wherein the conductive layer of the first composite is applied to the second composite by one selected from the group consisting of lamination and pressing, to produce a third composite;
(iv) optionally applying two antiblocking hardcoat layers, if not already present in step (i), to two faces of the third composite to produce a fourth composite; and
(vii) optionally applying two adhesive layers to two faces of the third or fourth composite to produce an alternative fourth or a fifth composite; and
(viii) optionally subjecting one of the third, fourth or fifth composite to overmolding or in-mold coating by an injection molding method.

7. A liquid-crystal device comprising the multilayer composite as claimed in claim 1, disposed between two sheets, wherein the conductive layers have been bonded by a voltage source.

8. A method of producing a liquid-crystal device as claimed in claim 7, comprising the following steps:
securing two sheets, each on one side of the multilayer composite as claimed in claim 1.

9. One selected from structural glazing, automotive glass, mirrors and glazing, floodlight covers, optical filters, shutters, flat visual display screens, glazed advertising devices, dividing walls of trains, and point-of-interest devices, comprising the liquid crystal device produced according to claim 7.
